(19) United States
(12) Patent Application Publication
(10) Pub. No.: US 2023/0061145 A1
(43) Pub. Date: Mar. 2, 2023

(54) LLC RESONANT CONVERTER WITH DIRECT POWER TRANSFORMER

(71) Applicant: MONOLITHIC POWER SYSTEMS, INC., San Jose, CA (US)

(72) Inventors: Dianbo FU, San Jose, CA (US); Daocheng HUANG, Santa Clara, CA (US); Junjie FENG, San Jose, CA (US)

(73) Assignee: Monolithic Power Systems, Inc., San Jose, CA (US)

(21) Appl. No.: 17/410,083

(22) Filed: Aug. 24, 2021

(51) Int. Cl. H02M 3/335; H02M 1/08

(52) U.S. Cl. CPC H02M 3/33576; H02M 1/08

(57) ABSTRACT

An LLC resonant converter includes a transformer, a switching half-bridge circuit, a resonant circuit, and a full-bridge rectifier. Both the switching half-bridge circuit and the full-bridge rectifier are on the same side of the transformer. The switching half-bridge circuit has a pair of switches, with one of the switches being connected to the output voltage node of the converter.

### TECHNICAL FIELD

The present invention is directed to LLC resonant converters and power supplies incorporating same.

### BACKGROUND

Converters are electrical circuits that convert an input voltage to an output voltage. An LLC resonant converter is a type of converter that converts a direct current (DC) input voltage to a DC output voltage using a resonant circuit that comprises a resonant capacitor, a resonant inductor, and a magnetizing inductance of a transformer. The LLC resonant converter includes a switching bridge circuit that transforms the input DC voltage to a square wave. The square wave excites the resonant circuit to output a sinusoidal signal, which gets scaled by a transformer. The scaled sinusoidal signal is rectified by a rectifier, and an output capacitor filters the rectified output to generate the DC output voltage. The switching bridge circuit and the rectifier are on opposite sides of a core of the transformer. More specifically, the switching bridge circuit is on a primary side (also referred to as “high-voltage side”) of the transformer, whereas the rectifier is on a secondary side (also referred to as “low-voltage side”) of the transformer.

Embodiments of the present invention pertain to an LLC resonant converter with a novel topology.

### BRIEF SUMMARY

In one embodiment, an LLC resonant converter comprises a transformer, a switching half-bridge circuit, a resonant circuit, and a full-bridge rectifier. Both the switching half-bridge circuit and the full-bridge rectifier are on the same side of the transformer, such as the secondary side. The switching half-bridge circuit has a pair of switches, one of which is connected to the output voltage of the converter. The resonant circuit comprises a resonant capacitor, a resonant inductor, and a magnetizing inductance of a first secondary winding of the transformer. The switching half-bridge circuit is connected to the first secondary winding of the transformer by way of the resonant circuit. The full-bridge rectifier is connected to a second secondary winding of the transformer.

In another embodiment, a power supply comprises a transformer, a switching half-bridge circuit, a resonant circuit, a full-bridge rectifier, and an LLC resonant controller. The transformer has a first secondary winding and a second secondary winding. The first secondary winding is connected to the second secondary winding on a same side of the transformer. The switching half-bridge circuit has a first transistor and a second transistor that form a switch node, with an end of the first transistor being connected to a DC input voltage and an end of the second transistor being connected to a DC output voltage. The resonant circuit comprises a resonant capacitor, a resonant inductor, and a magnetizing inductance of the first secondary winding of the transformer. The switching half-bridge circuit is connected to the first secondary winding of the transformer by way of the resonant circuit. The full-bridge rectifier is connected to the second secondary winding of the transformer. The LLC resonant controller is configured to generate control signals that control switching of the transistors of the switching half-bridge circuit and the full-bridge rectifier to generate the DC output voltage on an output capacitor.

In yet another embodiment, a method of generating an output voltage of an LLC resonant converter includes providing a DC input voltage to a switching half-bridge circuit. A first switch and a second switch of the switching half-bridge circuit are alternately switched to excite a resonant circuit to flow a sinusoidal current through a first secondary winding of a transformer. An end of a switch of the switching half-bridge circuit is connected to a DC output voltage of the LLC resonant converter. The sinusoidal current through the first secondary winding of the transformer induces a sinusoidal current to flow through a second secondary winding of the transformer. The first secondary winding is connected to the second secondary winding on the same side of the transformer. The sinusoidal current that flows through the second secondary winding of the transformer is rectified by a full-bridge rectifier. A rectified output of the full-bridge rectifier is filtered to generate the DC output voltage of the LLC resonant converter.

These and other features of the present disclosure will be readily apparent to persons of ordinary skill in the art upon reading the entirety of this disclosure, which includes the accompanying drawings and claims.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 shows a schematic diagram of an LLC resonant converter in accordance with an embodiment of the present invention.

FIG. 2 shows a schematic diagram of a power supply with the LLC resonant converter of FIG. 1 in accordance with an embodiment of the present invention.

FIG. 3 shows simulated waveforms of signals of the power supply of FIG. 2 in accordance with an embodiment of the present invention.

FIG. 4 shows the converter of FIG. 1 during a positive half cycle.

FIG. 5 shows the converter of FIG. 1 during a negative half-cycle.

FIG. 6 shows a flow diagram of a method of generating an output voltage of an LLC resonant converter in accordance with an embodiment of the present invention.

### DETAILED DESCRIPTION

In the present disclosure, numerous specific details are provided, such as examples of circuits, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

For illustration purposes, the transistors disclosed herein are metal-oxide-semiconductor-field-effect-transistors (MOSFETs) that each has a first end (e.g., drain), a second end (e.g., source), and a control end (e.g., gate). As can be appreciated, other types of transistors may also be employed with appropriate changes to the connections explained below.

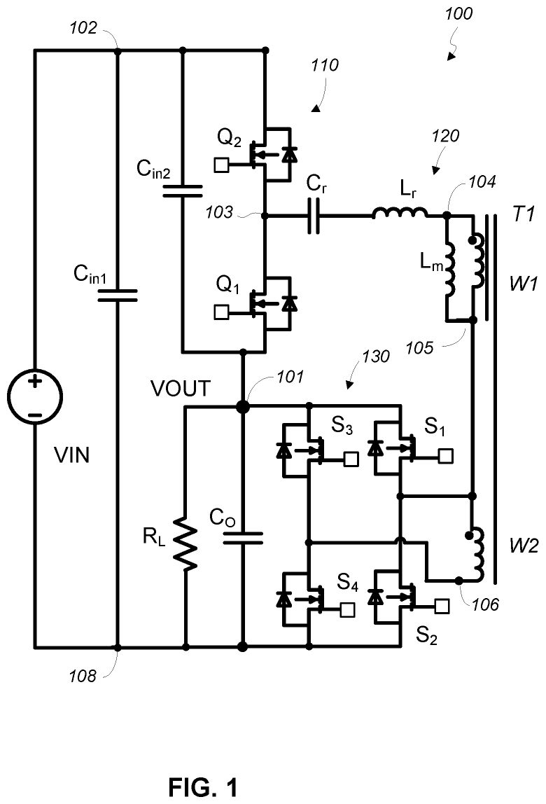

FIG. 1 shows a schematic diagram of an LLC resonant converter 100 in accordance with an embodiment of the present invention. In the example of FIG. 1, the converter 100 comprises a switching half-bridge circuit 110, a resonant circuit 120, a transformer T1, and a full-bridge rectifier circuit 130.

In the example of FIG. 1, the switching half-bridge circuit 110 comprises transistors Q1 and Q2. The drain of the transistor Q2 is connected to a positive end of a DC input voltage VIN at an input voltage node 102 and the source of the transistor Q2 is connected to the drain of the transistor Q1 at a switch node 103. The source of the transistor Q1 is connected to a DC output voltage VOUT at an output voltage node 101. An input capacitor Cin2 is across the transistors Q1 and Q2 for noise filtering.

A transformer T1 comprises a secondary winding W1 and a secondary winding W2. The secondary windings W1 and W2 are wound to have a polarity in accordance with the dot convention as shown. The secondary winding W1 has a magnetizing inductance Lm. As will be more apparent below, the switching half-bridge circuit 110 is not connected to a primary winding of the transformer T1. Instead, both the switching half-bridge circuit 110 and the full-bridge rectifier circuit 130 are connected to the same side of the core of the transformer T1, which is the secondary side in this example.

The resonant circuit 120 comprises a resonant capacitor Cr, a resonant inductor Lr, and the magnetizing inductance Lm of the secondary winding W1 of the transformer T1. The resonant capacitor Cr and the resonant inductor Lr form a series circuit that forms a resonant tank with the magnetizing inductance Lm. In the example of FIG. 1, the secondary winding W1 is connected to the switch node 103 by way of the series circuit formed by the resonant capacitor Cr and the resonant inductor Lr.

A first end of the resonant capacitor Cr is connected to the switch node 103 that is formed by the transistors Q2 and Q1, and a second end of the resonant capacitor Cr is connected to a first end of the resonant inductor Lr. A second end of the resonant inductor Lr is connected to a first end of the secondary winding W1 at a secondary winding node 104. A second end of the secondary winding W1 is connected to a secondary winding node 105.

The full-bridge rectifier circuit 130 comprises transistors S1, S2, S3, and S4. The drains of the transistors S3 and S1 are connected to the output voltage VOUT at the output voltage node 101. The sources of the transistors S4 and S2 are connected to the negative end of the input voltage VIN at the reference node 108. The source of the transistor S3 is connected to the drain of the transistor S4 to form a switch node that is connected to a second end of the secondary winding W2 at a secondary winding node 106. The source of the transistor S1 is connected to the drain of the transistor S2 to form a switch node that is connected to a first end of the secondary winding W2. The first end of the secondary winding W2 is connected to the second end of the secondary winding W1.

An input capacitor Cin1, which serves as a noise filter, is across the input voltage VIN. The output voltage VOUT is developed across an output capacitor Co, which filters the rectified output of the full-bridge rectifier circuit 130. A resistor RL represents the load of the converter 100.

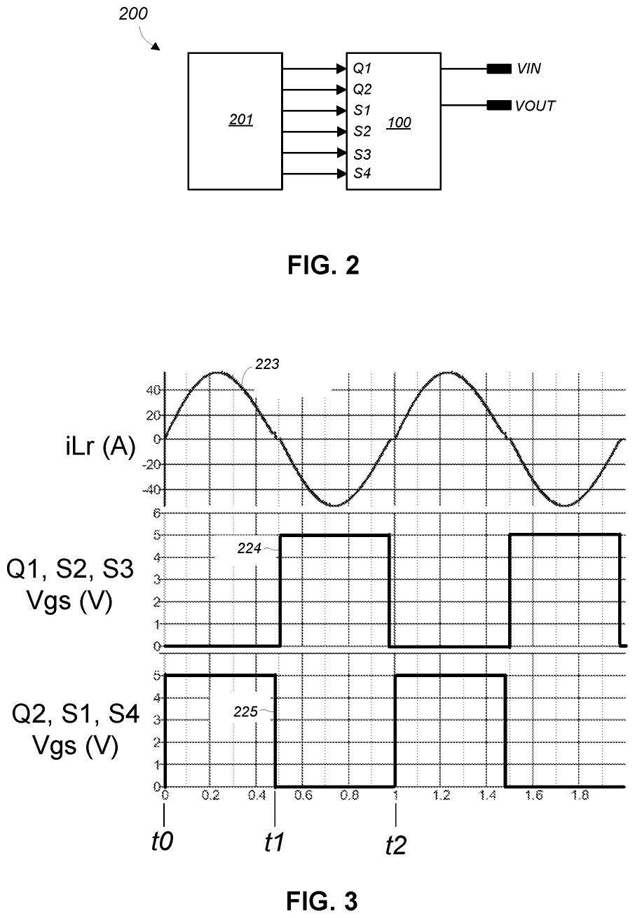

FIG. 2 shows a schematic diagram of a power supply 200 in accordance with an embodiment of the present invention. The power supply 200 comprises an LLC resonant controller 201 and the LLC resonant converter 100. The LLC resonant controller 201 may comprise a commercially-available LLC resonant controller or may be adapted from an existing LLC resonant controller. LLC resonant controllers are available from various vendors including Monolithic Power Systems, Inc. The controller 201 is configured to switch the transistors of the converter 100 (i.e., transistors Q1, Q2, S1, S2, S3, and S4) by generating control signals to drive the gates of the transistors. As is well-known, a control signal may switch a MOSFET by controlling its gate-to-source voltage.

The controller 201 controls the transistors Q1 and Q2 to generate, at the switch node 103, a square wave that excites the resonant circuit 120 to generate a sinusoidal signal. The sinusoidal signal is scaled by the turns ratio of the secondary windings W1 and W2, which in one embodiment is one-to-one (i.e., 1:1). The turns ratio of the secondary windings W1 and W2 may be adjusted for different scaling requirements. The controller 201 controls the transistors S1-S4 to rectify the scaled sinusoidal signal. The output capacitor Co filters the rectified signal to develop the output voltage VOUT, which is delivered to the load RL. Generally, the resonant circuit 120 works as a voltage divider. The impedance of the resonant circuit 120 increases when not in resonance, thereby lowering the output voltage VOUT. The controller 201 adjusts the switching frequency of the transistors Q1 and Q2, and thus the operating frequency of the resonant circuit 120, to maintain the output voltage VOUT within regulation.

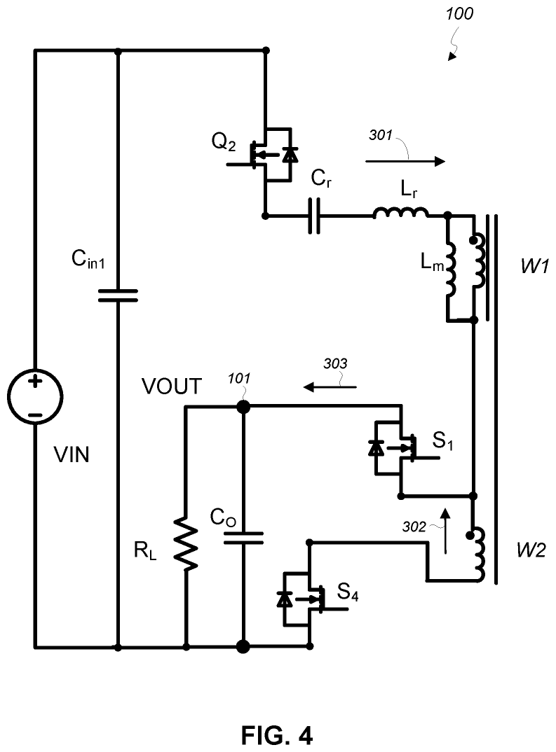

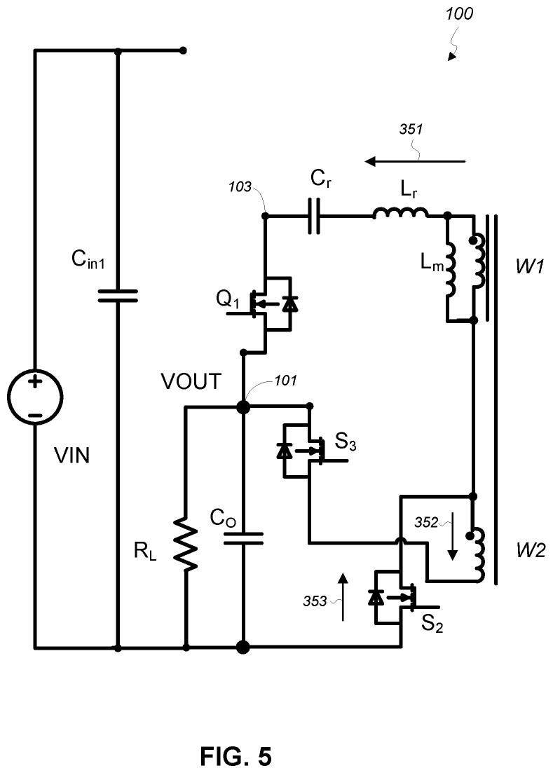

An example operation of the power supply 200 is now explained with reference to FIGS. 3-5. FIG. 3 shows simulated waveforms of signals of the power supply 200. FIGS. 4 and 5 show the converter 100 during a positive half cycle and a negative half-cycle, respectively.

FIG. 3 shows a waveform 223 of a current iLr through the resonant inductor Lr in amps (vertical axis). Note that the current iLr is sinusoidal. Accordingly, the currents through the secondary windings W1 and W2 are also sinusoidal.

In the example of FIG. 3, a waveform 224 is a gate-source voltage Vgs in volts (vertical axis) that is used as a control signal to switch a corresponding transistor Q1, S2, and S3. A waveform 225 is a gate-source voltage Vgs in volts (vertical axis) that is used as a control signal to switch a corresponding transistor Q2, S1, and S4. In the example of FIG. 3, the horizontal axis indicates time in microseconds. A time period t0-t1 is during a positive half-cycle when the current iLr is flowing in the positive direction, i.e., from the switch node 103 toward the secondary winding W1. A time period t1-t2 is during a negative half-cycle when the current iLr is flowing in the negative direction, i.e., from the secondary winding W1 toward the switch node 103.

FIG. 4 shows the converter 100 during the positive half-cycle, which is the time period t0-t1 in FIG. 3. During the positive half-cycle, the transistors Q2, S1, and S4 are ON, whereas the transistors Q1, S2 and S3 are OFF. Components that are not in play during the positive half-cycle are not shown in FIG. 4 for clarity of illustration.

When the transistor Q2 is ON and the transistor Q1 is OFF, the current iLr flows through the resonant inductor Lr in a positive direction toward the secondary winding W1 (see arrow 301). This is reflected by the positive value of the current iLr during this time (see FIG. 3, waveform 223 during t0-t1). In accordance with the transformer dot convention, the positive current iLr induces current to flow through the secondary winding W2 toward the source of the transistor S1 (see arrow 302), and through the transistor S1 (see arrow 303) toward the output voltage node 101. During the positive half cycle, the resulting current through each of the transistors S1 and Q2 is double of that through the transistor S4.

FIG. 5 shows the converter 100 during the negative half-cycle, which is the time period t1-t2 in FIG. 3. During the negative half-cycle, the transistors Q1, S2, and S3 are ON, whereas the transistors Q2, S1 and S4 are OFF. Components that are not in play during the negative half-cycle are not shown in FIG. 5 for clarity of illustration.

When the transistor Q1 is ON and the transistor Q2 is OFF, the current iLr flows through the resonant inductor Lr in a negative direction from the secondary winding W1 toward the switch node 103 (see arrow 351), and through the switch Q1 toward the output voltage node 101. This is reflected by the negative value of the current iLr during this time (see FIG. 3, waveform 223 during t1-t2). In accordance with the transformer dot convention, the negative current iLr induces current to flow through the secondary winding W2 in a direction toward the source of the transistor S3 (see arrow 352), and through the transistor S3 toward the output voltage node 101. In the example of FIG. 5, the resulting current through each of the transistor S2 (see arrow 353) and the transistor Q1 is double of that through the transistor S3.

In the converter 100, the current through each of the transistor Q1, transistor Q2, and the resonant capacitor Cr is doubled compared to conventional topologies. The increased current through the resonant capacitor Cr may result in slight efficiency loss. However, the slight efficiency loss is more than offset by numerous advantages brought about by the novel topology of the converter 100. First, a primary winding of the transformer T1 may be omitted, thereby allowing the transformer T1 to be mounted on a printed circuit board (PCB) with a reduced number of layers. Second, the direct current transfer from the input voltage VIN to the output voltage VOUT (because they are on the same side of the transformer T1) allows for reduced currents through the transistors S3 and S4. Third, the reduced number of transistors of the switching half-bridge circuit 110 provides a corresponding reduction in power loss and in the number of drivers required to drive the switching half-bridge circuit 110. Fourth, because the source of the transistor Q1 is connected to the output voltage VOUT, the source voltage of the transistor Q1 is more stable and generates less noise for the controller 201. Also, the drain-to-source voltage Vds of the transistors Q1 and Q2 is reduced by about 25%, e.g., to 75% of the input voltage VIN.

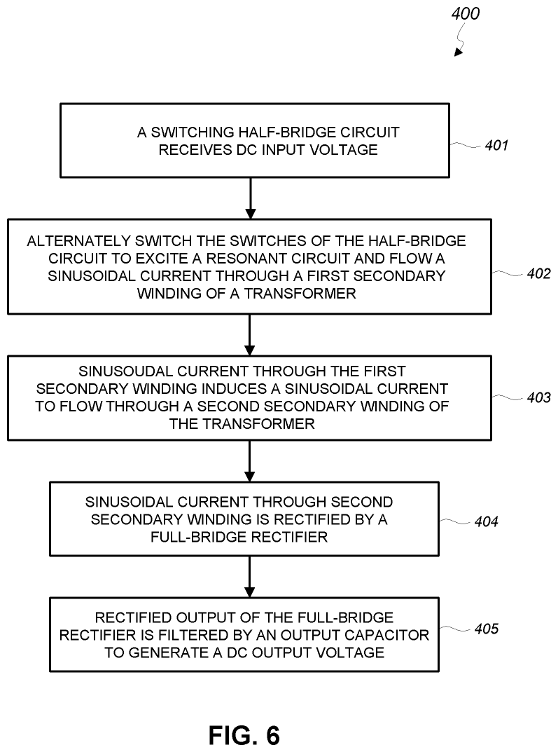

FIG. 6 shows a flow diagram of a method 400 of generating an output voltage of an LLC resonant converter in accordance with an embodiment of the present invention. The method 400 may be performed by the components of the converter 100. As can be appreciated, other components may also be employed without detracting from the merits of the present invention.

In the method 400, a switching half-bridge circuit receives a DC input voltage (step 401). The switching half-bridge circuit includes a pair of switches that are alternately switched ON and OFF to excite a resonant circuit and flow a sinusoidal current through a first secondary winding of a transformer (step 402). The sinusoidal current through the first secondary winding of the transformer induces a sinusoidal current to flow through a second secondary winding of the transformer (step 403). The sinusoidal current through the second secondary winding of the transformer is rectified by a full-bridge rectifier (step 404). The rectified output signal of the full-bridge rectifier is filtered by an output capacitor to generate a DC output voltage that is received by a load (step 405).

A novel LLC resonant converter and a power supply incorporating same have been disclosed. While specific embodiments of the present invention have been provided, it is to be understood that these embodiments are for illustration purposes and not limiting. Many additional embodiments will be apparent to persons of ordinary skill in the art reading this disclosure.

What is claimed is:

1. An LLC resonant converter comprising:
a transformer comprising a first secondary winding and a second secondary winding, the first secondary winding being connected to the second secondary winding on a same side of the transformer;
a switching half-bridge circuit comprising a first transistor and a second transistor, a first end of the first transistor being connected to a DC input voltage, a second end of the first transistor being connected to a first end of the second transistor, and a second end of the second transistor being connected to a DC output voltage at an output voltage node;
a resonant circuit comprising a resonant capacitor, a resonant inductor, and a magnetizing inductance of the first secondary winding of the transformer, the resonant circuit being connected to a switch node formed by the first and second transistors of the switching half-bridge circuit; and
a full-bridge rectifier that is connected to the second secondary winding to generate a rectified output signal that is filtered to generate the DC output voltage at the output voltage node.

2. The LLC resonant converter of claim 1, further comprising:
an output capacitor comprising a first end that is connected to the output voltage node and a second end that is connected to a reference node, wherein a load is connected across the output node and the reference node.

3. The LLC resonant converter of claim 1, wherein the resonant capacitor and the resonant inductor form a series circuit, a first end of the series circuit is connected to the second end of the first transistor and to the first end of the second transistor, and a second end of the series circuit is connected to a first end of the first secondary winding.

4. The LLC resonant converter of claim 3, wherein a second end of the first secondary winding is connected to a first end of the second secondary winding.

5. The LLC resonant converter of claim 4, wherein the full-bridge rectifier comprises a third transistor, a fourth transistor, a fifth transistor, and a sixth transistor.

6. The LLC resonant converter of claim 5, wherein a first end of the third transistor is connected to the output voltage node, and a second end of the third transistor is connected to a first end of the fourth transistor and to the first end of the second secondary winding.

7. The LLC resonant converter of claim 6, wherein a first end of the fifth transistor is connected to the output voltage node, a second end of the fifth transistor is connected to a first end of the sixth transistor and to a second end of the second secondary winding, and a second end of the sixth transistor is connected to a second end of the fourth transistor.

8. The LLC resonant converter of claim 7, further comprising:
an output capacitor comprising a first end that is connected to the first ends of the third and fifth transistors and a second end that is connected to the second ends of the fourth and sixth transistors.

9. The LLC resonant converter of claim 8, wherein each of the first, second, third, fourth, fifth, and sixth transistors comprises a metal-oxide-semiconductor-field-effect-transistor (MOSFET).

10. A power supply comprising:
a transformer comprising a first secondary winding and a second secondary winding, the first secondary winding being connected to the second secondary winding on a same side of the transformer;
a switching half-bridge circuit comprising a first transistor and a second transistor that forms a switch node, an end of the first transistor being connected to a DC input voltage and an end of the second transistor being connected to a DC output voltage at an output voltage node;
a resonant circuit comprising a resonant capacitor, a resonant inductor, and a magnetizing inductance of the first secondary winding, the resonant circuit being connected to the switch node formed by the first and second transistors;
a full-bridge rectifier that is connected to the second secondary winding to generate a rectified output signal that is filtered by an output capacitor; and
an LLC resonant controller that is configured to generate control signals that control switching of the first transistor, the second transistor, and transistors of the full-bridge rectifier to generate the DC output voltage on the output capacitor.

11. The power supply of claim 10, wherein a load is connected to the full-bridge rectifier by way of an output capacitor.

12. The power supply of claim 10, wherein the switching half-bridge circuit is connected to a first end of the first secondary winding by way of the resonant capacitor and the resonant inductor, and a second end of the first secondary winding is connected to a first end of the second secondary winding.

13. The power supply of claim 12, wherein the full-bridge rectifier comprises a third transistor, a fourth transistor, a fifth transistor, and a sixth transistor.

14. The power supply of claim 13, wherein the first end of the second secondary winding is connected to a switch node formed by the third and fourth transistors, and a second end of the second secondary winding is connected to a switch node formed by the fifth and sixth transistors.

15. The power supply of claim 14, further comprising:
an input capacitor that is across the DC input voltage.

16. A method of generating an output voltage of an LLC resonant converter, the method comprising:
providing an input voltage to a switching half-bridge circuit;
alternately switching a first switch and a second switch of the switching half-bridge circuit to excite a resonant circuit and flow a sinusoidal current through a first secondary winding of a transformer;
rectifying, by a full-bridge rectifier, a sinusoidal current that flows through a second secondary winding of the transformer, the sinusoidal current through the second secondary winding being induced by the sinusoidal current through the first secondary winding, wherein the first secondary winding and the second secondary winding are connected on a same side of the transformer; and
filtering a rectified output of the full-bridge rectifier to generate the output voltage of the LLC resonant converter.

17. The method of claim 16, wherein filtering the rectified output of the full-bridge rectifier includes placing an output capacitor across the full-bridge rectifier.

18. The method of claim 16, wherein alternately switching the first switch and the second switch comprises:
during a positive half-cycle, switching OFF the first switch and switching ON the second switch to flow the sinusoidal current through the first secondary winding and away from the second switch.

19. The method of claim 16, wherein alternately switching the first switch and the second switch comprises:
during a negative half-cycle, switching ON the first switch and switching OFF the second switch to flow the sinusoidal current through the first secondary winding toward the first switch.

20. The method of claim 19, wherein alternately switching the first switch and the second switch comprises:
during the negative half-cycle, switching ON the first switch and switching OFF the second switch to flow the sinusoidal current through the first secondary winding toward the output voltage of the LLC resonant converter through the first switch.
